(19) United States
(12) Patent Application Publication
(10) Pub. No.: US 2006/0002832 A1
(43) Pub. Date: Jan. 5, 2006

(54) Selectable closed-loop phosphatizing wash & rinse system and method

(75) Inventor: Raymond Niedzwiecki, Palo Alto, CA (US)

Correspondence Address: BEYER WEAVER & THOMAS LLP, P.O. BOX 70250, OAKLAND, CA, 94612-0250, US

(73) Assignee: EZ ENVIRONMENTAL SOLUTIONS CORPORATION, A California Corporation, MENLO PARK, CA (US)

(21) Appl. No.: 11/129,731

(22) Filed: May 13, 2005

Related U.S. Application Data
(60) Provisional application No. 60/572,695, filed on May 19, 2004.

(51) Int. Cl. B01J 8/04

(52) U.S. Cl. 422/188

(57) ABSTRACT

A phosphatizing system for phosphatizing an object including a subfloor assembly for supporting an object, and adapted to direct excess run-off fluids which are flowed over the object and collected at a run-off discharge port thereof. A closed-loop phosphatizing assembly is configured to pass a phosphatizing reagent run-off fluid over the object during a phosphatizing procedure, and a having reagent fluid reservoir in fluid communication with the run-off discharge port for receipt of substantially all the reagent run-off fluids from said subfloor assembly. A rinse system is configured to pass a rinsing solution over the object to rinse the reagent run-off fluid therefrom during a finishing rinse procedure performed after the phosphatizing procedure, and having a rinse fluid reservoir in fluid communication with the run-off discharge port for receipt of substantially all the rinsing/reagent run-off fluids from said subfloor assembly. A switch assembly is fluidly coupled between said run-off discharge port and the reagent fluid reservoir and the rinse fluid reservoir, and switchable between a first condition and a second condition. In the first condition, the reagent run-off fluids are directed to the reagent fluid reservoir during the phosphatizing procedure, while in the second condition, the rinsing/reagent run-off fluids are directed to the rinse fluid reservoir during the rinse procedure, wherein said collected reagent run-off fluids in said reagent fluid reservoir are not diluted by the rinsing/reagent run-off fluids.

### CROSS-REFERENCE TO RELATED APPLICATION

This application claims priority to U.S. Provisionary Patent Application No. 60/572,695 filed May 19, 2004, which is hereby incorporated by reference in its entirety.

### FIELD OF THE INVENTION

The present invention relates generally to methods and apparatus for use in phosphatizing. More particularly, the present invention relates to methods and apparatus for phosphatizing objects with a closed loop pressure washer and phosphatizer system, or similar device, and recovering and recycling rinse solution to replenish evaporated phosphatizing solution.

### BACKGROUND OF THE INVENTION

Contamination of the environment by man-made substances has been considered a serious problem for a long time. Recently, concern about contamination of earth, air, and groundwater by oil, toxic chemicals, and other hazardous wastes has expanded beyond large-scale industry to encompass the activities of many small businesses including automobile service stations, and many others. Both government regulations and social outcry have placed tremendous pressure on these businesses to avoid discharging hazardous wastes into the environment in the course of ordinary business activities.

Many businesses partake in activities that are likely to produce waste that may be harmful to the environment. For example, in an automobile service station, washing or steam-cleaning auto parts, e.g., an automobile engine, often causes engine oil, gasoline, and other chemicals to enter a storm drain system, or other waterways, thereby leading to the potential contamination of groundwater. In addition, those who service remotely located equipment generally have a need to wash the equipment without discharging hazardous waste into the environment. By way of example, persons who service roof-mounted air conditioners that contain lubricating petrochemicals, trapped pollutants, or other chemicals are not permitted to wash the equipment in a manner that could cause chemicals to run off the roof and into the surrounding environment.

These environmental concerns also apply to phosphatizing metal objects that is a pre-treatment process of metal for powder coating or wet painting. More specifically, in this process, a low concentration of phosphate solution reacts with the iron in the composition to create an iron phosphate coating. Similar to iron oxidation, the phosphate binds up with the site to form a coating that prevents further oxidation. Thus, this surface oxidation or etching creates an acceptable porous surface for the powder coating to statically adhere to the metal, and an acceptable surface for wet painting. Subsequently, the powder is heat cured to bond the powder to the treated surface.

Phosphatizing is usually a commercial multi-stage procedure where the main process of phosphatizing is typically performed through a dipping bath or spraying application. Generally, phosphatizing is performed by large commercial establishments having relatively large and costly conveyor-type systems which move the metallic objects to be phosphatized systematically through each process stage. Depending upon the quality of the paint desired, more intermediate stages are added which increases the quality of the painting. In these costly conveyor-type assemblies, however, the primary stages prior to powdering usually include a cleaning process, a phosphatizing process, and a finishing rinse.

The cleaning stage is usually performed using a heated spray application of water to the surface of the object under high pressures of between about 500 psi to about 2500 psi, depending upon the metal composition. This washing procedure removes any loose particles, surface oils or the like which may adversely affect the formation of the iron phosphate coating on the metallic surface during the phosphatizing stage. In conveyor-type systems, such high pressure cleaning is usually applied by spraying the object through pressurized nozzles strategically located about the conveyor assembly in the cleaning station. Since these nozzles are usually fixed relative the conveyor assembly, cleansing coverage of the metallic object is often limited.

The next stage of the procedure is the phosphatizing step where the pressure cleaned objects is phosphatized using a primarily heated solution of 1% to 5% phosphoric acid solution. Chemical constituents of phosphate solution will vary from manufacturer to manufacturer.

In large conveyor-type systems, this stage is usually applied in a spray application to bathe and rinse the object in the phosphate solution. Similar to the washing station, the phosphatizing station includes a plurality of strategically placed spray nozzles fixed about the station. Therefore, coverage of the phosphate solution on the object is limited in the same manner as in the washing bath. To some extent, this limits the coverage dimensions of iron phosphate coating that is dependent upon several factors including the phosphate concentration, the coverage of the spray application and the amount of reaction time.

The final stage of the phosphatizing process is the finishing rinse stage where de-ionized water is preferably employed to rinse the phosphoric acid solution from the object to inhibit further phosphatizing of the object surface. In effect, this finishing rinse procedure halts the reaction by removing the phosphatizing reagent from the surface of the coated object. It is important, however, to rinse the phosphatized object from a source of continuous clean de-ionized water to assure proper rinsing of the object. De-ionized water even slightly contaminated with phosphoric acid will not properly halt further reaction of the phosphatizing process. Thus, this rinsing solution must not be reused, and is discarded after use.

Due to environmental restrictions, this contaminated refuse must be treated before being discarded into the environment. Thus, hazardous waste disposal units must be contracted, or other costly disposal processes are applied such as the application of phosphate neutralizers to the waste before being discarded. In other instances, evaporators or the like must be employed to evaporate the water, leaving hazardous solid phosphates wastes for removal.

While these large conveyor-type phosphatizing systems are adequate for large commercial establishments with large productions, they are not practical for most mid-size or smaller establishments with substantially less resources and production capabilities. For one, these systems are relatively costly and require relatively large areas of manufacture space. Further, the maintenance costs of the systems are substantial. For example, the recommended use of de-ionized water for the washing, phosphatizing and rinsing stage collectively results in substantial production costs. Due to the volume of de-ionized solutions employed in each stage, water de-ionizing units to de-ionize tap water are employed as a continuous source of de-ionized water. However, this process itself is time consuming and costly to maintain. The Resin beds necessary to de-ionize the water are expensive and are easily contaminated. Thus, replacement is very frequent.

Thus, many phosphatizing units attempt to conserve the de-ionized water or even eliminate the use of de-ionized water. Regular tap water may be utilized to replace the costly de-ionized water in one of or all of the cleaning, phosphatizing and finishing rinse stages. This replacement, however, is often not recommended since the amount of dissolved solids/contaminants in the tap water varies depending upon the water source. Moreover, during the evaporation/replenishing cycles of tap water in phosphate solution, the build-up of dissolved solids/contaminants in the phosphate solution adversely affects the cleaning process. Thus, it is preferred to employ de-ionized water in the cleaning, the phosphatizing and the finishing rinse procedures to reduce the number of dissolved solids/contaminants in the phosphate solution.

In other phosphatizing procedures, the rinse stage may be eliminated altogether. This technique is problematic, however, since it is then difficult to control the depth of the iron phosphate coating. Accordingly, while these cost savings applications reduce production costs, the quality of the phosphatizing are jeopardized in most instances.

### SUMMARY OF THE INVENTION

The present invention relates to a phosphatizing system for phosphatizing an object including a subfloor assembly for supporting an object, and adapted to direct excess run-off fluids that are flowed over the object and collected at a run-off discharge port thereof. A closed-loop phosphatizing assembly is configured to pass a phosphatizing reagent run-off fluid over the object during a phosphatizing procedure, and having reagent fluid reservoir in fluid communication with the run-off discharge port for receipt of substantially all the reagent run-off fluids from said subfloor assembly. A rinse system is configured to pass a rinsing solution over the object to rinse the reagent run-off fluid therefrom during a finishing rinse procedure performed after the phosphatizing procedure, and having a rinse fluid reservoir in fluid communication with the run-off discharge port for receipt of substantially all the rinsing/reagent run-off fluids from said subfloor assembly. A switch assembly is fluidly coupled between said run-off discharge port and the reagent fluid reservoir and the rinse fluid reservoir, and switchable between a first condition and a second condition. In the first condition, the reagent run-off fluids are directed to the reagent fluid reservoir during the phosphatizing procedure, while in the second condition, the rinsing/reagent run-off fluids are directed to the rinse fluid reservoir during the rinse procedure, wherein said collected reagent run-off fluids in said reagent fluid reservoir are not diluted by the rinsing/reagent run-off fluids.

Accordingly, depending upon whether the procedure is a phosphatizing wash cycle or a rinse cycle, the run-off fluid collected and flowing through the discharge port is automatically directed, via the switching assembly, into either the reagent fluid reservoir containing only phosphatizing reagent fluid or the rinse fluid reservoir containing the run-off rinse/reagent fluid. During the wash/phosphatizing procedure, the run-off reagent fluid is diverted back into the reagent fluid reservoir where the contaminated run-off reagent fluid is filtered and recirculated in a closed-loop manner through the closed-loop phosphatizing system. During the subsequent rinse cycle with fresh or de-ionized water, however, the runoff is not permitted to flow back into the reagent fluid reservoir, diluting the concentration of the phosphatizing agent in the solution. Rather, the switch assembly is activated to switch to divert the run-off rinse/reagent run-off fluid, flowing through the discharge port, into a separate rinse fluid reservoir. All detrimental mixing of the rinse/reagent run-off with the reagent fluid contained in the reagent reservoir is avoided.

In one embodiment, the switch assembly includes a valve mechanism selectively operable between the first condition, directing the reagent run-off fluids to the reagent fluid reservoir, and a second condition, directing the rinsing/reagent run-off fluids to the rinse fluid reservoir. This valve mechanism can be provided by a 3-way valve or a pair of 2-way valves.

In another specific configurations, a timer device is included that is coupled to the switching mechanism to delay, for a predetermined period, switching to the first condition from the second condition when switching from the rinse procedure to the phosphatizing procedure. This delay is preferably about 20 seconds.

In another aspect of the present invention, a method for phosphatizing an object is provided including supporting the object through a subfloor assembly including a support floor having a run-off discharge port thereof; and phosphatizing the object, during a phosphatizing procedure, through a closed-loop phosphatizing assembly by passing a phosphatizing reagent run-off fluid over the object. The method further includes collecting the reagent run-off fluids in the run-off discharge port, and directing the reagent run-off fluids into a reagent fluid reservoir of the phosphatizing assembly for reuse thereof. Next, the method includes rinsing the object, during a finishing rinse procedure, through a rinsing assembly by passing a rinsing solution over the object, and collecting the rinsing/reagent run-off fluids in the run-off discharge port. Finally, the method includes directing the rinsing/reagent run-off fluids into a rinse fluid reservoir of the rinsing assembly for collection thereof, wherein the collected reagent run-off fluids in the reagent fluid reservoir are not diluted by the rinsing/reagent run-off fluids during the rinsing procedure.

### BRIEF DESCRIPTION OF THE DRAWINGS

The method and assembly of the present invention has other objects and features of advantage which will be more readily apparent from the following description of the Detailed Description of the Embodiments and the appended claims, when taken in conjunction with the accompanying drawing, in which:

FIG. 1 is a side elevation view of the closed-loop wash, phosphatizing and rinse assembly constructed in accordance with the present invention.

FIG. 2 is a schematic diagram of the closed-loop cleaning assembly of FIG. 1.

FIG. 3 is a top plan view of the wash reservoir and the rinse water reservoir containment assemblies of the system of FIG. 1.

FIG. 4 is a top plan view of the support assembly positioned above the wash reservoir and the rinse water reservoir containment assemblies of the system of FIG. 1.

FIG. 5 is a side elevation view of the system of FIG. 4.

FIG. 6 is a top plan view of the wash reservoir and the rinse water reservoir containment assemblies mounted to a rolling frame unit.

FIG. 7 is an alternative embodiment schematic diagram of the closed-loop cleaning assembly of FIG. 2, incorporating an overflow drain and a water source selector valve.

FIG. 8 is an alternative embodiment schematic diagram of the closed-loop cleaning assembly of FIG. 7, without the overflow drain.

FIG. 9 is an alternative embodiment schematic diagram of the closed-loop cleaning assembly of FIG. 7, incorporating a rinse pump filter assembly.

FIG. 10 is a side elevation view, in cross-section, of an adjustable connector assembly enabling universal mounting of a cone shield to a spray gun shaft.

FIG. 11 is another alternative embodiment schematic diagram of the closed-loop cleaning assembly of FIG. 1.

### DETAILED DESCRIPTION OF THE EMBODIMENTS

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

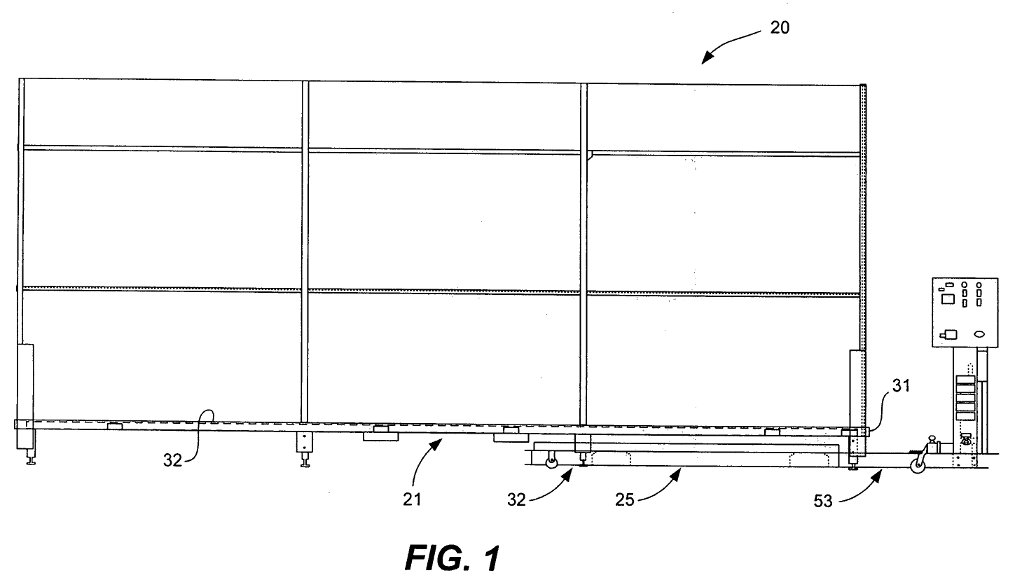

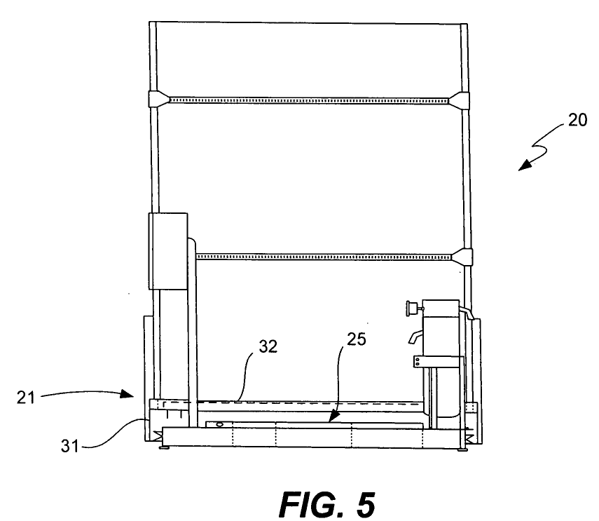

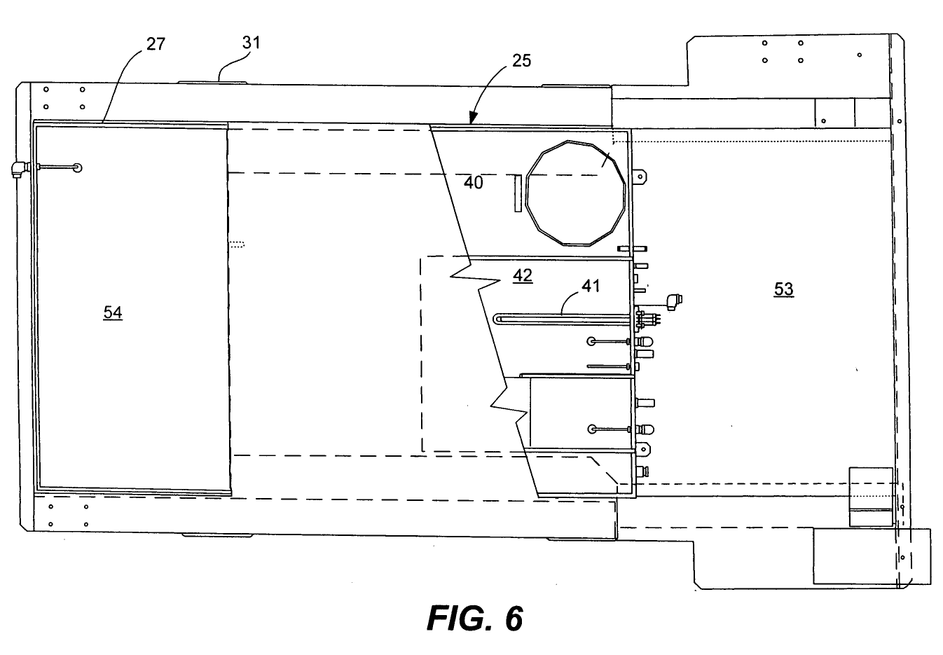

Attention is now directed to FIGS. 1-6 where a Selectable Closed-Loop Phosphatizing Wash & Rinse system, generally designated 20, is illustrated for phosphatizing, cleaning and rinsing an article or object supported atop a wash platform or subfloor assembly 21. The subfloor assembly 21 is configured to support the object, and adapted to direct excess run-off fluids that are flowed over the object and collected at a run-off discharge port 22 thereof. A closed-loop phosphatizing assembly, generally designated 23, is configured to pass a phosphatizing reagent run-off fluid over the object during a phosphatizing procedure. The phosphatizing assembly includes a reagent fluid reservoir 25 in fluid communication with the run-off discharge port 22 for receipt of substantially all the reagent run-off fluids from the subfloor assembly 21. The system further includes a rinse system 26 configured to pass a rinsing solution over the object to rinse the reagent run-off fluid therefrom during a finishing rinse procedure performed after the phosphatizing procedure. The rinse system 26 includes a rinse fluid reservoir 27 in fluid communication with the run-off discharge port 22 for receipt of substantially all the rinsing/reagent run-off fluids from the subfloor assembly 21. A switch assembly, generally designated 28, is fluidly coupled between the run-off discharge port 22, the reagent fluid reservoir 25 and the rinse fluid reservoir 27. This switch assembly is switchable between a first condition and a second condition. In the first condition, during the phosphatizing procedure, the reagent run-off fluids are directed to the reagent fluid reservoir 25. In contrast, in the switch second condition, during the rinse procedure, the rinsing/reagent run-off fluids are directed to the rinse fluid reservoir wherein the collected reagent run-off fluids in the reagent fluid reservoir are not diluted by the rinsing/reagent run-off fluids.

Accordingly, depending upon whether the procedure is a phosphatizing wash cycle or a rinse cycle, the run-off fluid collected and flowing through the discharge port is automatically directed, via the switching assembly, into either the reagent fluid reservoir containing only phosphatizing reagent fluid or the rinse fluid reservoir containing the run-off rinse/reagent fluid, which essentially is a mixture of the rinse fluid and the rinsed-off phosphatizing reagent fluid. Hence, during the wash/phosphatizing procedure, the run-off reagent fluid is diverted back into the reagent fluid reservoir 25 where the contaminated run-off reagent fluid is filtered and recirculated in a closed-loop manner through the closed-loop phosphatizing system. The concentration of the phosphatizing agent in the washing fluid recirculating in this closed-loop reservoir can be maintained at a desired concentration level for a substantially longer time. Unlike the current designs, during the subsequent rinse cycle with fresh or de-ionized water, the runoff is not permitted to flow back into the reagent fluid reservoir 25, diluting the concentration of the phosphatizing agent in the solution. Rather, the switch assembly 28 is switched to divert the run-off rinse/reagent run-off fluid, flowing through the discharge port, into a separate rinse fluid reservoir 27. All detrimental mixing of the rinse/reagent run-off with the reagent fluid contained in the reagent reservoir is avoided. Consequently, time consuming titration cycles of the phosphate reagent fluid are substantially reduced, and the concentration of the expensive phosphates in the washing fluid is maintained at the desired level and not diluted like the current phosphatizing designs.

Referring to FIGS. 1 and 3-6, the present invention will now be described in greater detail. In one specific embodiment, the wash platform or subfloor assembly 21 is supported over both the reagent fluid reservoir 25 of the phosphatizing assembly 23 and the rinse fluid reservoir of the rinse system 26 by a base frame 31. The base frame is a generally rectangular structure of conventional design comprising four base side frames, although it should be appreciated that base frame 31 may take on any suitable shape. The base frame 31 preferably includes an upper support frame having lateral beams that are joined to cross beams that are formed and dimensioned to support the subfloor assembly 21 above the phosphatizing assembly 23 and the rinse system 26. It will be understood, however, that these assemblies do not need to be positioned underneath the subfloor. The lateral beams and the cross beams may be welded aluminum or stainless steel tube stock, structural fiberglass, as for example EXTREN®, or any other sturdy material which is essentially non-corroding.

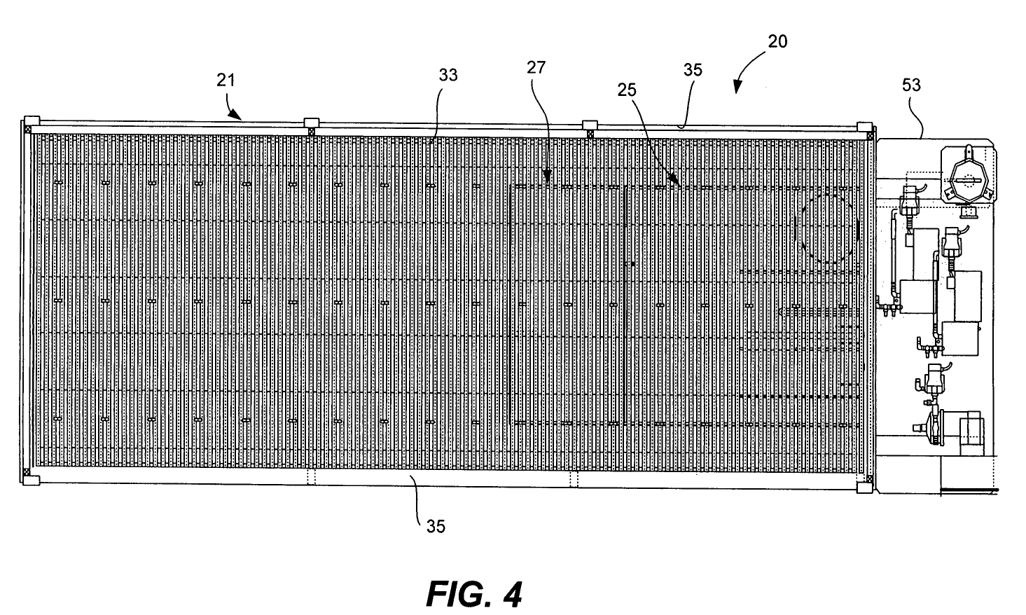

The subfloor assembly 21 further includes a bottom support floor 32 (FIG. 4) and may include a metal or fiberglass grate assembly 33 positioned thereatop. The grate assembly 33 supports the object so that it does not come into direct contact with the support floor 32, which itself is configured to direct the excess run-off fluids during the phosphatizing and finishing rinse procedures into a peripherally surrounding collection gutter device 35. As best illustrated in FIG. 4, the gutter device 35 peripherally surrounds the support floor 32 to collect the run-off fluids. The gutter device 35 directs the run-off fluids into the single discharge port 22, which is fluidly coupled to the switch assembly 28.

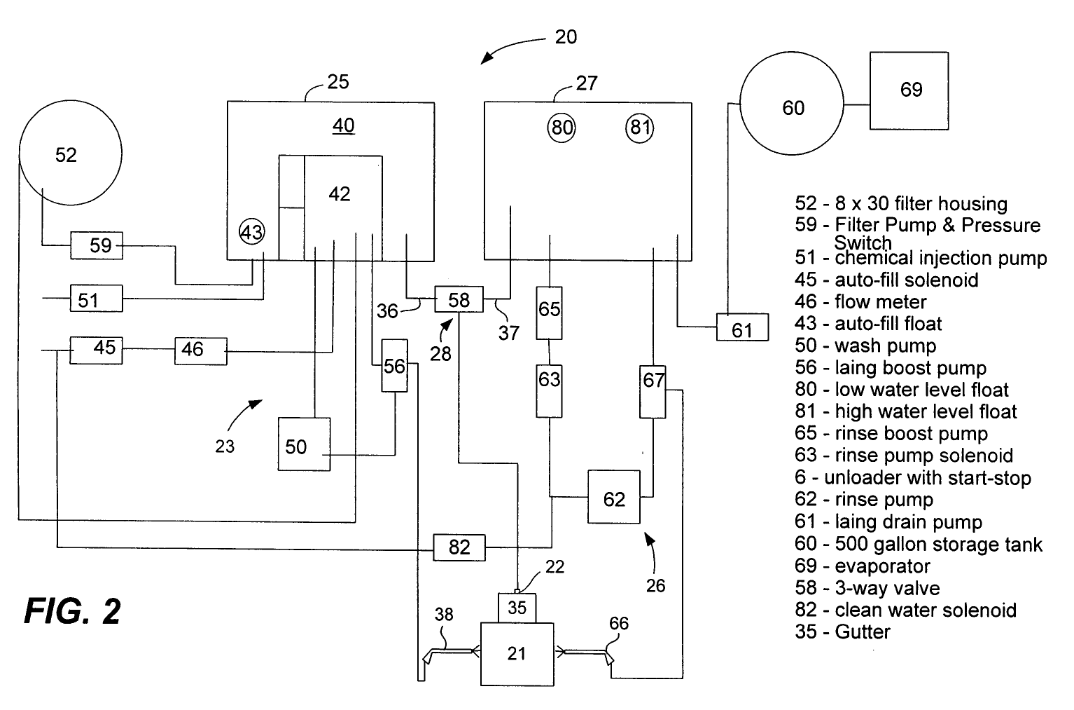

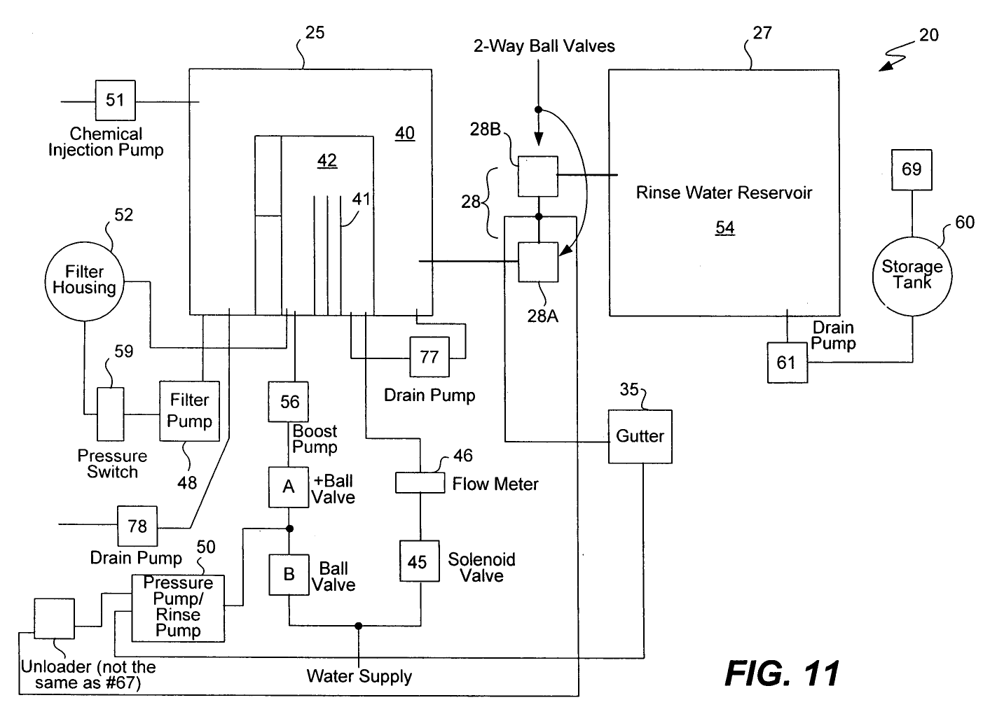

As mentioned, this switch assembly is fluidly coupled between the reagent fluid reservoir 25 of the closed-loop phosphatizing assembly (via line 36) and the rinse fluid reservoir 27 of the rinse system 26 (via line 37, in FIG. 2). The switch assembly 28, in one specific embodiment, is provided by a conventional three-way ball valve switchable between a first condition and a second condition. In the first condition, the run-off reagent fluid can be returned to the reagent fluid reservoir 25, while in the second condition, the run-off rinse/reagent fluid is diverted to the rinse fluid reservoir 27. In another specific embodiment, as shown in FIG. 11, a pair of 2-way ball valves 28A and 28B may be applied in parallel that collectively perform the same function.

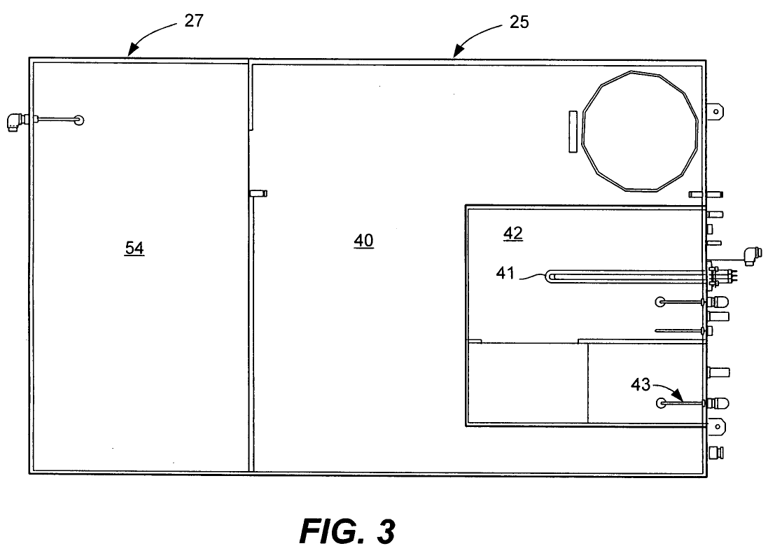

In one specific embodiment, a pressure cleaning procedure and the phosphatizing procedure are combined in a single cleaning/phosphatizing procedure using a spray application of a low concentration phosphoric acid solution for both cleaning and phosphatizing applications. This cleaning/phosphatizing assembly 23, as shown in FIG. 3, preferably employs a closed-loop pressure cleaning system adapted for spray applications using conventional pressure wands 38 (FIG. 2). Briefly, these closed-loop cleaning/phosphatizing assemblies 23 are adapted to recirculate the reagent run-off fluid in a collection chamber 40 in a manner systematically filtering out contaminants contained in the recirculated reagent run-off fluid. The oils may also be skimmed off the surface, and the reagent run-off fluid may further be urged through a bag filter (not shown). It will be appreciated that while any closed-loop containment assembly may be used, the present invention is illustrated for use with our U-flow containment apparatus that is disclosed U.S. Pat. Nos. 6,120,614 and 6,402,855 both of which are incorporated herein by reference in their entirety.

In these closed-loop systems, by providing an adequate settling time and a relatively slow recirculation flow in a U-shaped collection chamber 40 of the reagent fluid reservoir 25, the contaminants may be separated from the reagent run-off fluid through gravity filtration. Thus, these reagent fluid reservoir configurations enable the natural separation of the lightweight components from the heavyweight components suspended in the collected reagent run-off fluid in the reagent fluid reservoir 25 (FIG. 3). Briefly, by providing a flow path that is relatively slow (about 0.5 gallons/min. to about 8.5 gallons/min, and more preferably about 2.0 gallons/min.), relatively non-turbulent and uniform, separation of the contaminants can naturally occur.

Thus, the slow recirculating reagent run-off fluid in the collection chamber 40 is constantly filtering out contaminants contained therein as the solution recirculates through the system. The cleaning/phosphatizing assembly 23 further heats the reagent run-off fluid through a heating element 41 that is in fluid communication with the reagent run-off fluid in a clean fluid chamber 42 of the reagent fluid reservoir 25. In one embodiment, the heating element 41 for this assembly will be provided by a single screw-in heater that contains three elements for a balanced electrical load. Temperature sensing and control is performed through a RTD probe and a Programmable Logic Control (PLC), and the temperature displayed on the PLC. The temperature can be adjusted, via reprogramming, to a maximum of 160 degrees Fahrenheit. Preferably, however, this heating element 41 heats the reagent run-off fluid to a temperature in the range of about 120° F. to about 160° F. for pressure cleaning thereof.

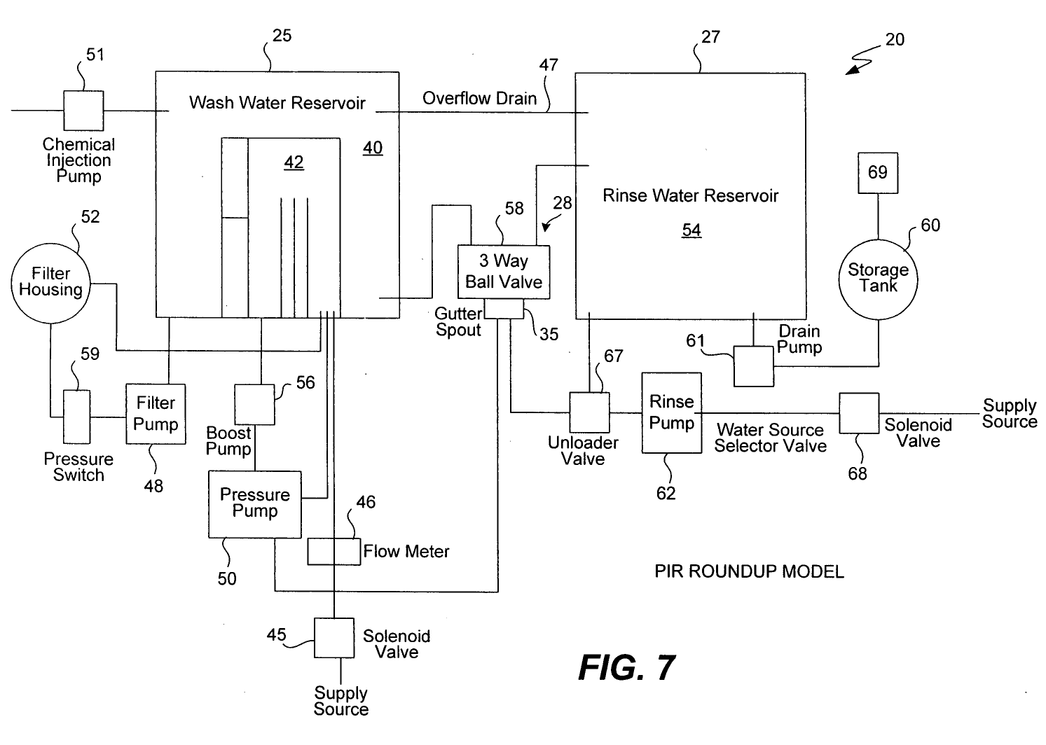

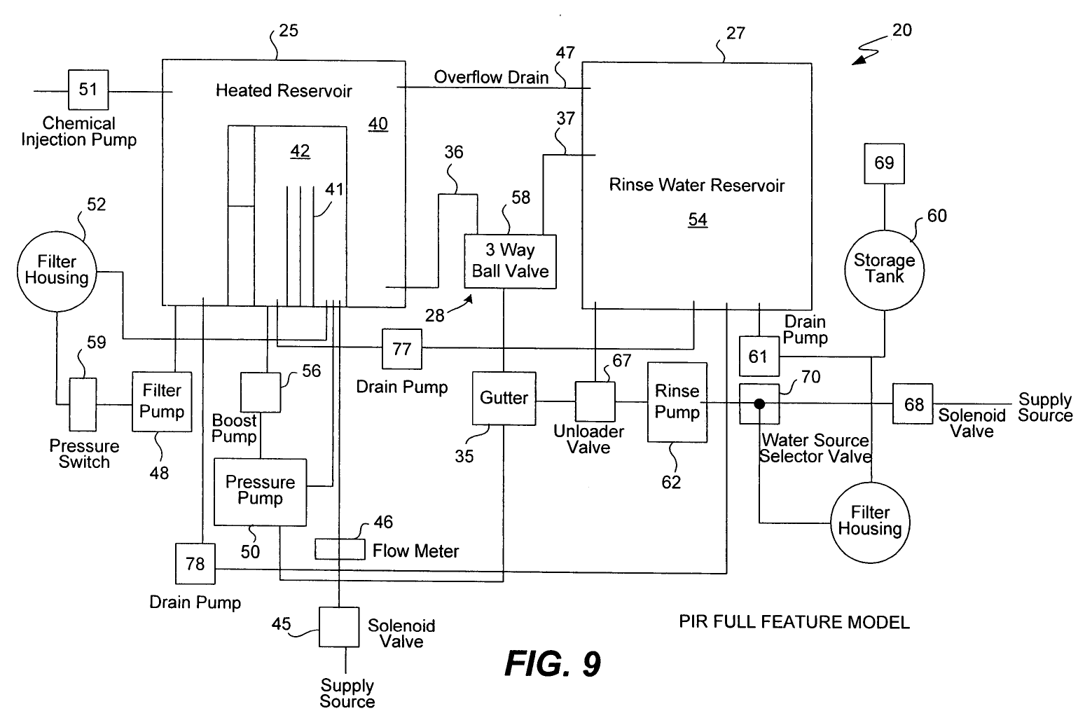

Thus, the evaporation rate of the recirculating reagent run-off fluid in the reagent fluid reservoir 25 is relatively high, and ultimately results in a substantial loss of the phosphatizing reagent run-off fluid. The temperature of the reagent run-off fluid, of course, may be selectively varied to conform to manufacturer and chemical specifications of the phosphatizing reagent run-off fluids employed. To assure non-exposure of the heating element, a low-water level float 43 is provided in the fluid reservoir 25 to measure the fluid level. In the event the low-water level float 43 senses too low of a fluid level, an auto-fill mode is activated by the PLC that permits incoming fresh water to be provided through a solenoid valve 45 into the reagent fluid reservoir 25. A flow meter 46 will is disposed between the auto-fill solenoid 45 and the inlet to the hot clean fluid chamber 42. The auto-fill solenoid 45 and the inlet to the tank will be about ¾″ in diameter. The flow meter 46 depends on this size opening throughout the circuit to accurately measure the water flowing into the reagent fluid reservoir 25. A high water level float can be included in one embodiment to prevent overflow. Alternatively, or in addition to, an overflow drain 47 can be provided from the heated reagent fluid reservoir 25 to the rinse fluid reservoir 27, as shown in FIGS. 7 and 9.

Briefly, the PLC is applied to control all closed-loop cleaning assembly operations including water temperature, auto-fill, filter-pressure shut-off (shut down closed-loop cleaning assembly operation), wash pump and boost pump, closed-loop cleaning assembly warm up (24 hour-7 day timer function), 3-way valve operation with appropriate delays, and the rinse water drain pump. For example, the PLC can be programmed to automatically heat the collected reagent run-off fluid in the closed-loop phosphatizing assembly up to the required operating temperature before the start of the first shift each day with a manual mode for off-hour operation. In this arrangement, the filter pump 48 will circulate the water in the closed-loop cleaning assembly until the desired temperature has been reached. The reagent fluid filter pump 48 will not resume operation until the pressure wash pump 50 is turned on. The heater will cycle on & and off during the dwell period (if any) to keep the clean reagent fluid in the clean fluid chamber up to temperature at all times. Further, the PLC will assure that the wash pump and the rinse pump do not operate simultaneously. The heater temperature, start times and chemical balance are also all available to be reprogrammed by the end user using the simple controls on the face of the PLC.

To maintain the proper proportion of the phosphate concentration, a Chemical Injection Pump 51 automatically injects the correct proportion of phosphates, relatively the measured amount of fluid flowing through the flow meter, as shown in the embodiments of FIGS. 7 and 9. The Chemical Injection Pump 51 is preferably provided by a Peristaltic Pump that together with the PLC and its controller are selected to inject the chemistry in the proper, user selected, proportions (i.e., the phosphate concentration). For example, the PLC will count the pulses determined by the flow meter, and transmit a signal to the peristaltic pump controller for the peristaltic pump 51 and inject the appropriate volume of chemistry to match the incoming water. An input for this pump 51 is a flow meter as well. The mixture ratio will be user adjustable over a range likely between about 50 to 1 and 50 to 4, water to chemical.

Briefly, the collected run-off reagent fluid in the collection chamber 40 is drawn through a filter assembly 52 with an intake fluidly coupled to the collection chamber and with an output fluidly coupled to the clean fluid chamber 42. A filter pump 48 pushes the contaminated run-off phosphatizing reagent fluid through filter assembly 52 which directs the flow back into the hot clean fluid chamber 42 where it is heated through heating element 41. In one configuration, a Pacer Pump is used as the filter pump 48 with the upgraded material for the housing and impeller. Inlet and outlet sizes of the pump are 1″. A pressure switch will be mounted to a 1″ NPT Tee; the Tee location may be at the outlet of the pump or the inlet of the filter housing. The filter housing, preferably an 8×30 stainless filter housing with 1″ hose barbs, is applied together with a 20-micron oil absorbing filter bag.

A support housing 53 contains most of the necessary plumbing, motors, pumps etc. (not shown) to operate the cleaning/phosphatizing assembly 23, as shown in FIGS. 1 and 4-6. Moreover, the spray application is provided by a pressure spray wand 38 having a high pressure wash pump 50 (FIG. 2) in fluid communication with the clean reagent run-off fluid in the clean fluid chamber 42. In one embodiment shown in FIG. 2, a stainless CAT pressure wash pump 50 and unloader 55 are fed by a Laing Boost pump 56. The pressure wash pump 50 may be any conventional high pressure pump assembly, and is preferably capable of providing a variable pressure for a selective pressure spray application. One such conventional pressure pump, for example, is that provided by WANNER, Model No. MD3EABJSSECA, which is capable of providing a low pressure spray in the range of about 50 psi and a high pressure spray in the range of about 3000 psi.

In one embodiment, the combined cleaning/phosphatizing procedure is comprised of a high pressure cleaning procedure and a low pressure phosphatizing procedure using the common heated reagent run-off fluid. Applying a stainless steel spray nozzle 57 (FIG. 11) and spray wand 38 (FIG. 2), for compatibility purposes, the operator can direct a high pressure spray of the heated reagent run-off fluid at the object for a thorough cleaning. This high pressure cleaning procedure removes any loose contaminants, surface oils, etc., from the surface of the metallic object to be cleaned. Preferably, for the combined cleaning/phosphatizing procedure, the reagent run-off fluid is maintained at a substantially high temperature in the range of about 80° F. to about 212° F., and more preferably in the range of about 140° F. to about 160° F., while the high pressure spray is maintained in the range of about 100 psi to about 3000 psi. In a conventional high pressure cleaning procedure, such high pressure is not suitable for the phosphatizing procedure since this high pressure spray would also remove iron phosphate coating formation on the surface of the object. Therefore, once the cleaning procedure is completed, the cleaning assembly switches the spray application to a low pressure spray application to merely soak or wet the object surface with the same phosphatizing reagent run-off fluid. This low pressure spray application is preferably performed in the range of about 20 psi to about 200 psi. Thus, while a spray application is preferred, any other wetting technique may be employed to introduce the reagent run-off fluid to the object surface during the phosphatizing procedure.

On another embodiment, however, the pressure spray and phosphate application are performed simultaneously, with not low pressure phosphatizing application. This latter technique has proven to be very effective, especially when time is of the essence.

Accordingly, the cleaning and phosphatizing assembly of the present invention can accommodate a wide variety of operational requirements. Depending upon the composition of the materials being cleaned or phosphatized, the drain, flow, rinse, and phosphatizing parameters are all variable, and can all be changed within the system.

In accordance with the present invention, the excess reagent run-off fluids flowed over the object is diverted back to the reagent fluid reservoir where the fluid is reheated and cleaned for reapplication. Once the object is cleaned and wetted during the cleaning and phosphatizing spray applications, the excess run-off fluids flow onto the support floor 32 of the subfloor assembly 21. Briefly, it will be understood that during the finishing rinse procedure, the excess rinsing/reagent run-off fluids also flow onto the support floor as well. This support floor 32 is preferably configured to gravity flow or funnel the run-off fluids toward the edges of the support floor where the run-off is collected in the peripherally surrounding gutter device 35. This collected fluid run-off in the gutter device is then gravity flowed toward the discharge port 22 on one side of the support floor 32. It will be appreciated, however, that any other fluid transfer techniques, however, may be employed without departing from the true spirit and nature of the present invention.

During the rinse procedure, as mentioned, the 3-way valve 58 can be actuated to immediately divert the run-off collected in the peripheral gutter device 35 into the collection chamber 40 of the rinse fluid reservoir 27. Hence this rinse water does not flow into the collection chamber 40 for the reagent fluid reservoir 25 where it can dilute the concentration of the phosphate agent in the wash fluid for the washing cycle.

The rinse system 26 is a completely independent system containing a moderately sized, stainless steel rinse fluid reservoir 27 defining a collection compartment 54. This is preferably sized to hold approximately 40 gallons of rinse water. A storage tank 60 is fluidly coupled to the rinse fluid reservoir to store the collected rinse/reagent run-off fluid, and will be used as an additional buffer for collected rinse/reagent run-off fluid storage prior to evaporation by the evaporator 69 or haul-off. In one configuration, the storage tank 60 preferably has a capacity of from 150-200 gallons.

A drain pump 61, such as a Laing Pump, is applied to pump the collected rinse/reagent run-off fluid from the rinse fluid reservoir 27 (¾″ hose barb) to the storage tank 60. This tank will also contain a high level and low-level float to control the drain pump 61. In contrast, a rinse pump 62 is provided to perform the rinsing procedure. In one configuration, an UDOR 1000 psi, 2.2-gp, brass rinse pump 62 will be utilized for the rinse water function. It will be fed by a ¾″ brass solenoid 63 that is connected to the incoming water line (and in front of the water flow meter). The solenoid 63 is engaged when the WASH-RINSE switch is in the RINSE position. The rinse system 26 may include an independent spray wand 66 (FIG. 2) to perform all rinse procedures and applications.

In accordance with the present invention, the closed-loop phosphatizing assembly is not designed to operate during the rinse procedure so that the phosphatizing procedure and the rinse procedure cannot be performed simultaneously. The rinse pump 62 will also be equipped with an unloader valve 67 that will shut off the pump motor whenever the pump is in bypass mode. This is done so that no excess water will be allowed to flow into the rinse water tank. In one example, the output volume will be set at 2.2 gpm and pressures maintained below 500 psi.

When the mode selector switch is placed in the rinse mode, all of the wash mode functions will cease. The 3-way valve 58 will close the wash water port and open the rinse water port. The fresh water solenoid 63 for the rinse pump 62 will open and the rinse pump motor will be activated as soon as the trigger on the rinse spray wand 66 is activated. Whenever the trigger is released, the pump motor will be de-energized as a result of the signal received from the unloader valve 67. This feature prevents unnecessary water from entering the rinse water reservoir.

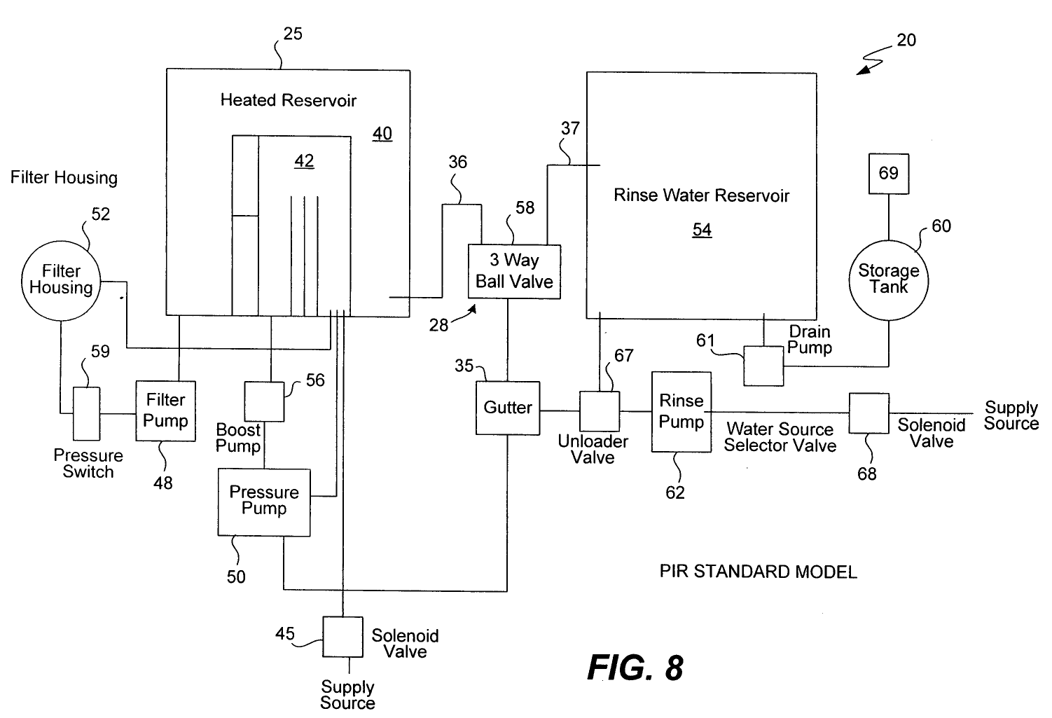

Another solenoid valve 68 in front of the inlet to the rinse pump 62 could be disposed so that the rinse pump 62 does not receive any rinse water unless the rinse procedure has been selected or commenced (FIGS. 7-9). This assures that the rinse fluid does not flow through the rinse pump 62 and unloader valve 67, and unnecessarily fills the rinse fluid reservoir 27. In another configuration, an unloader valve 67 with a set of contacts may be provided so that the rinse pump 62 can be turned off whenever the rinse gun trigger is not actuated. In this manner, bypass fluid is prevented from filling the tank unnecessarily.

During the rinse procedure, an additional valve 70 can be installed between the rinse water drain pump 61 and the inlet to the rinse pump 62. As shown in FIG. 9, the rinse water can be reused if desired. A filter housing 71 would also be added to prevent contamination from damaging the rinse pump 62. The auto-drain feature would drain the wash water reservoir into the rinse water reservoir and from there into the storage tank 60.

The rinse fluid reservoir 27 has a low level float to prevent water from going below the flooded-inlet height of the pump (pump is turned off) and a high level float to turn the pump on when the reservoir needs to be emptied. The water is pumped to a storage tank 60 that is also equipped with a high water level float. If this float is activated, the operation of the entire closed-loop cleaning assembly ceases until the water level has been adjusted.

Accordingly, as mentioned, the general premise of the system of the present invention is that the heated reagent fluid reservoir 25 will not have any additional rinse/reagent run-off fluid introduced into closed-loop phosphatizing system as a result of the rinse operation. The 3-way ball valve 58 will direct all rinse/reagent run-off fluid to the rinse fluid reservoir 27. The timing of this valve's operation should insure little or no rinse water entering the collection chamber 40 of the reagent fluid reservoir 25. Hence, upon operation of the rinse procedure, the valve should switch immediately to the second condition where the rinse/reagent run-off fluid is directed into the rinse fluid reservoir 27. In contrast, when switching from the rinse procedure to the phosphatizing procedure, operation of the switch assembly is delayed for a predetermined period such that the valve 58 may initially direct a small amount of reagent run-off fluid into the rinse fluid reservoir 27. This assures that the collected rinse/reagent run-off fluid still flowing in the gutter device will not flow into the reagent fluid reservoir 25.

Such delay is handled by the PLC, and is preferably about 20 seconds. A smaller or greater delay can be accommodated as well. When the selector switch is returned to the wash/phosphatizing position, the 3-way valve 58 will delay switching back to the first condition for approximately 20 seconds so that fresh rinse fluid or water does not enter the reagent fluid reservoir 25 without being accounted for by the flow meter. Hence, when the pressure pump 35 is restarted, the filter pump 48 will resume operation and the three-way valve 58 will then switch to the first condition after the predetermined delay, directing wash water back to the wash water reservoir.

In the configuration of FIGS. 7 and 9, as mentioned, an overflow drain option 47 may be provided. In another option, as shown in FIG. 9, The clean collected reagent fluid in the clean fluid chamber 42 could be pumped into the collection compartment 54 of the rinse water reservoir 27 through a drain pump 77, and then on to the storage tank. Another drain pump 78 can pump the collected reagent run-off fluid directly into the collection compartment 54 as well. Two Laing pumps could be applied for this purpose.

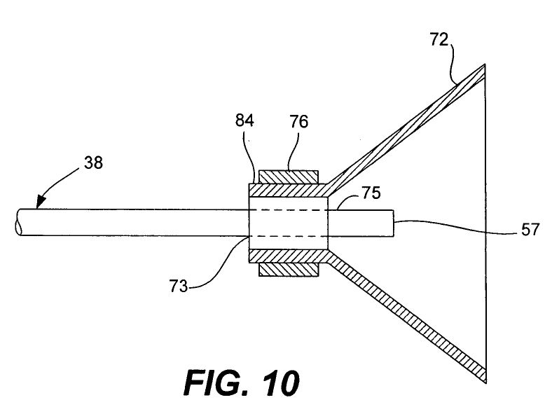

Referring now to FIG. 10, a cross section of a nozzle cone 72 is shown having a spray nozzle 57 that outputs a jet spray of fluid. A conical end piece is fitted having a compressible washer material 73 between the funnel of the cone and the exterior circumferential surface 75 of the spray nozzle. Applying a clamp device 76 to the outer circumferential surface 84 of the funnel of the cone, the compressible washer material 73 enables a universal fit that can be applied to varying diameters of spray nozzles 57. Examples of such compressible materials include the GOODYEAR® Black Horizon ½″ hose or the TYSON® 3370 silicone 7.8½″ I.D. hose.

In another specific embodiment, as shown in FIG. 11, the wash pump 50 is also applied for the rinse pump duties. During the wash/phosphatizing procedure, the boost pump 56 supplies reagent fluid when 2-way ball valve 85A is in an open position and 2-way ball valve 85B in a closed position. During the rinse procedure, 2-way ball valve 85A is in a closed position, while 2-way ball valve 85B is moved to an opened position. This enables fresh water from the water supply source to the inlet of the pressure pump 56. Incidentally, similar to the switching assembly 28, the pair of 2-way ball valves 85A and 85B can be replaced with a single 3-way valve to perform the same function.

The configuration shown in FIG. 11 is also advantageous in that a flush procedure may also be performed that allows flushing of the bearing of the pressure pump, extending the life of the pressure pump 56. It has been found that the phosphatizing components in the reagent fluid tend to crystallize and leave deposits on the pump seals when exposed to the reagent fluids for longer periods of time, such as overnight or over the weekend. When this occurs, the deposits or crystals cause damage to the internal components of the pump. Accordingly, the configuration of the present invention enables flushing of the pressure pump components with fresh water during the rinse procedure.

An unloader valve 86 is also provided that directs the flow from the pressure pump 56 to the switching assembly 28. In one embodiment, when the unloader valve 86 is opened, the unit will shut off the pump motor whenever in bypass mode.

In another embodiment, an unloader valve 86 is also provided that directs the flow from the pressure pump 56 to the switching assembly 28.

What is claimed is:

1. A phosphatizing system for phosphatizing an object comprising:
a subfloor assembly for supporting an object, and adapted to direct excess run-off fluids which are flowed over the object and collected at a run-off discharge port thereof;
a closed-loop phosphatizing assembly configured to pass a phosphatizing reagent run-off fluid over the object during a phosphatizing procedure, and a having reagent fluid reservoir in fluid communication with the run-off discharge port for receipt of substantially all the reagent run-off fluids from said subfloor assembly;
a rinse system configured to pass a rinsing solution over the object to rinse the reagent run-off fluid therefrom during a finishing rinse procedure performed after the phosphatizing procedure, and having a rinse fluid reservoir in fluid communication with the run-off discharge port for receipt of substantially all the rinsing/reagent run-off fluids from said subfloor assembly; and
a switch assembly fluidly coupled between said run-off discharge port and the reagent fluid reservoir and the rinse fluid reservoir, and switchable between a first condition, directing the reagent run-off fluids to the reagent fluid reservoir during the phosphatizing procedure, and a second condition, directing the rinsing/reagent run-off fluids to the rinse fluid reservoir during the rinse procedure, wherein said collected reagent run-off fluids in said reagent fluid reservoir are not diluted by the rinsing/reagent run-off fluids.

2. The phosphatizing system as defined in claim 1, wherein
said switch assembly includes a valve mechanism selectively operable between the first condition, directing the reagent run-off fluids to the reagent fluid reservoir, and a second condition, directing the rinsing/reagent run-off fluids to the rinse fluid reservoir.

3. The phosphatizing system as defined in claim 2, wherein
said valve mechanism is provided by a 3-way ball valve or a pair of 2-way ball valves.

4. The phosphatizing system as defined in claim 1 further including:
a timer device coupled to said switching mechanism to delay, for a predetermined period, switching to the first condition from the second condition when switching from the rinse procedure to the phosphatizing procedure.

5. The phosphatizing system as defined in claim 5 further including:
said predetermined period is about 20 seconds.

6. The phosphatizing system as defined in claim 1 wherein,
said reagent run-off fluid includes a phosphoric acid component and a de-ionized water component, and
said rinsing solution is composed of de-ionized water.

7. The phosphatizing system as defined in claim 1 wherein,
said phosphatizing procedure is performed through a spray application.

8. The phosphatizing system as defined in claim 7 wherein,
said phosphatizing assembly is further adapted for a combined pressure wash/phosphatizing spray application.

9. The phosphatizing system as defined in claim 1 wherein,
said phosphatizing assembly further includes a heating element in fluid contact with the collected reagent run-off fluid in said reagent fluid reservoir for controlled heating thereof.

10. The phosphatizing system as defined in claim 1, further including;
a storage tank fluidly coupled to said rinse fluid reservoir for storage of said rinsing/reagent run-off fluids.

11. A method for phosphatizing an object comprising:
supporting the object through a subfloor assembly including a support floor having a run-off discharge port thereof;
phosphatizing the object, during a phosphatizing procedure, through a closed-loop phosphatizing assembly by passing a phosphatizing reagent run-off fluid over the object;
collecting the reagent run-off fluids in said run-off discharge port;
directing the reagent run-off fluids into a reagent fluid reservoir of the phosphatizing assembly for reuse thereof;
rinsing the object, during a finishing rinse procedure, through a rinsing assembly by passing a rinsing solution over the object;
collecting the rinsing/reagent run-off fluids in said run-off discharge port;
directing the rinsing/reagent run-off fluids into a rinse fluid reservoir of the rinsing assembly for collection thereof,
wherein the collected reagent run-off fluids in said reagent fluid reservoir are not diluted by the rinsing/reagent run-off fluids during the rinsing procedure.

12. The method for phosphatizing an object as recited in claim 11 wherein,
said phosphatizing the object is performed by spraying said object.

13. The method for phosphatizing an object as recited in claim 12 wherein,
said reagent run-off fluid includes a phosphoric acid component and a de-ionized water component, and
said rinsing the object is performed by spraying said object with a rinsing solution of uncontaminated de-ionized water or tap water.

14. The method for phosphatizing an object as recited in claim 11 wherein,
said directing the reagent run-off fluids and directing the rinsing/reagent run-off fluids is performed switching a switching assembly, fluidly coupled between said run-off discharge port and the reagent fluid reservoir and the rinse fluid reservoir, between a first condition, allowing passage of the run-off fluids to the reagent fluid reservoir while simultaneously preventing passage thereof to the rinse fluid reservoir, and a second condition, allowing passage of the run-off fluids to the rinse fluid reservoir while simultaneously preventing passage thereof to the reagent fluid reservoir.

15. The method for phosphatizing an object as recited in claim 14 further including:
delaying, for a predetermined period, the switching to the first condition from the second condition when switching from the rinse procedure to the phosphatizing procedure.

16. The method for phosphatizing an object as recited in claim 15 wherein,
said predetermined period is about 20 seconds.

17. The method for phosphatizing an object as recited in claim 15 wherein,
